(19) United States
(12) Patent Application Publication
(10) Pub. No.: US 2011/0069225 A1
(43) Pub. Date: Mar. 24, 2011

(54) METHOD AND SYSTEM FOR TRANSMITTING AND PROCESSING HIGH DEFINITION DIGITAL VIDEO SIGNALS

(75) Inventors: Nicholas Routhier, Candiac (CA); Étienne Fortin, Saint-Basile-Le-Grand (CA)

(73) Assignee: SENSIO TECHNOLOGIES INC., Montreal (CA)

(21) Appl. No.: 12/566,404

(22) Filed: Sep. 24, 2009

(51) Int. Cl. H04N 7/01; H04N 5/38; H04N 7/12

(52) U.S. Cl. 348/443; 348/723; 375/240.25; 348/E05.093; 348/E07.003; 375/E07.027

(57) ABSTRACT

A method of transmitting a digital video stream having a plurality of image frames and being characterized by a vertical resolution and a frame rate. A temporal multiplexing operation is applied to the image frames of the video stream in order to generate a compressed video stream having the same vertical resolution and half the frame rate of the video stream. This compressed video stream is then transmitted in lieu of the original video stream. At the receiving end, temporal de-multiplexing and pixel interpolation operations are applied to the frames of the compressed video stream in order to reconstruct the original video stream.

### TECHNICAL FIELD

This invention relates to the field of digital image transmission and more specifically to a method and system for transmitting and processing high definition digital video signals.

### BACKGROUND

High-definition television (HDTV), which is a digital television broadcasting system with higher resolution than traditional television systems (standard-definition TV or SDTV), has risen in popularity alongside large screen and projector-based viewing systems. HDTV yields a better-quality image than either analog television or regular DVD, because it has a greater number of lines of resolution. The visual information is some 2-5 times sharper because the gaps between the scan lines are narrower or invisible to the naked eye. The larger the size of the television the HD picture is viewed on, the greater the improvement in picture quality.

HDTV broadcast systems are identified with three major parameters:
Frame size—The frame size is defined as number of horizontal pixels×number of vertical pixels, for example 1280×720 or 1920×1080. Note that the number of horizontal pixels is often implied from context and is omitted. The number of horizontal pixels corresponds to the number of vertical scan lines of display resolution, while the number of vertical pixels corresponds to the number of horizontal scan lines of display resolution.
Scanning system—The scanning system is identified with the letter p for progressive scanning or i for interlaced scanning. With the interlaced scanning method, the X lines of resolution are divided into pairs. The first X/2 alternate lines are painted on a frame and then the second X/2 lines are painted on a second frame. The progressive scanning method simultaneously displays all X lines on every frame. Thus, a progressive frame contains double the image information than that of an interlaced frame, such that the progressive scanning method requires greater bandwidth than the interlaced scanning method.
Frame rate—The frame rate is identified as number of video frames per second however, for interlaced systems, an alternative form of specifying number of fields per second is often used instead.

If all three parameters are used, they are specified in the following form: [frame size] [scanning system] [frame rate]. Often, one parameter can be dropped if its value is implied from context, in which case, the remaining numeric parameter is specified first, followed by the scanning system. For example, 1920×1080p25 identifies progressive scanning format with 25 frames per second, each frame being 1920 pixels wide and 1080 pixels high. The 1080i30 or 1080i60 notation identifies interlaced scanning format with 60 fields (30 frames) per second, each frame being 1920 pixels wide and 1080 pixels high. The 720p60 notation identifies progressive scanning format with 60 frames per second, each frame being 720 pixels high, 1280 pixels horizontally are implied.

Non-cinematic HDTV video recordings intended for broadcast are typically recorded either in 720p60 or 1080i60 format, as determined by the broadcaster. While 720p60 presents a complete 720-line frame to the viewer 60 times each second, 1080i60 presents the picture 60 partial 540-line “fields” per second, which the human eye or a deinterlacer built into the display device must visually and temporally combine to build a 1080-line picture. Although 1080160 has more scan lines than 720p60, they do not translate directly into greater vertical resolution. Interlaced video is usually blurred vertically (filtered) to prevent a flickering of fine horizontal lines in a scene, lines that are so fine that they only occur on a single scan line. Because only half of the scan lines are drawn per field, fine horizontal lines may be missing entirely from one of the fields, causing them to flicker. Images are blurred vertically to ensure that no detail is only one scan line in height. Therefore, 1080i60 material does not deliver 1080 scan lines of vertical resolution. However, 1080i60 provides a 1920-pixel horizontal resolution, greater than 720p60s 1280 resolution.

The data rate is also a concern in broadcasting. Transmission of greater total pixel rates from all virtual channels multiplexed on a physical TV channel (whether a TV station or on a digital cable) requires greater video data compression. Excessive lossy compression can look much worse than a lower resolution with less compression, which in turn affects the choice of 720p or 1080i, and low or high frame rate. When a smoother image is desirable, for example for a fast-action sports telecast, 720p60 is likely preferred. However, for a crisper picture, particularly in non-moving shots, 1080i60 may be preferred. Another factor in the choice of 720p60 for a broadcast may be the fact that this system imposes less strenuous storage and decoding requirements compared to 1080i60.

1080p, which is sometimes referred to as “full high definition”, usually assumes a widescreen aspect ratio of 16:9, implying a horizontal resolution of 1920 pixels. The typical frame rate in hertz associated with this high resolution material is 24 Hz or 30 Hz (i.e. 24 or 30 frames per second), 1080p24 having actually become an established production standard for digital cinematography. For live broadcast applications, a high-definition progressive scan format operating at 1080p at 50 or 60 frames per second is obviously very desirable, since it would provide a high resolution video at double the data rate (as compared to 1080i60), without the presence of interlacing artifacts. Unfortunately, this format would require a whole new range of studio equipment, including cameras, storage equipment and editing equipment, in order to be able to handle a data rate that is essentially double the current data rate of 50 or 60 interlaced fields of 1920×1080 (i.e. 1080i50 or 1080i60). In both the United States and Europe, widespread availability of 1080p60 programming is currently impossible due to the current bandwidth limitations of the broadcasting channels and the fact that the existing digital receivers in use are incapable of decoding the more advanced codec (e.g. H.264/MPEG-4 AVC) associated with 1080p60.

In light of the foregoing, it seems clear that the current broadcasting standards, the programming limitations of widespread equipment (e.g. digital receivers and consumer televisions) and the bandwidth limitations imposed by the existing broadcast channels are such that 1080p video is currently only supported at the frame rates of 24, 25 and 30 frames per second. Accordingly, in practice, 1080p is quite rare in live broadcasting, as most major networks use a 60 Hz format (e.g. 720p60 or 1080i60.

Consequently, there exists a need in the industry to provide an improved method and system for transmitting and processing high definition digital video signals, whereby legacy broadcasting equipment and the existing broadcast channels currently in widespread use can support 1080p60 video and other such high resolution/high frame rate video.

### SUMMARY

In accordance with a broad aspect, the present invention provides a method of transmitting a digital video stream, the video stream having a plurality of image frames and being characterized by a vertical resolution and a frame rate. The method includes applying a temporal multiplexing operation to the image frames of the video stream in order to generate a compressed video stream having the same vertical resolution and half the frame rate of the video stream, and transmitting the compressed video stream.

In a particular embodiment, applying a temporal multiplexing operation includes identifying first and second image frames that are time-successive within the video stream, sampling the pixels of the first and second frames according to at least one predefined sampling pattern, thereby decimating half a number of original pixels from each frame, and creating a new image frame by merging together the sampled pixels of the first frame and the sampled pixels of the second frame.

In a specific, non-limiting example of implementation, the video stream is a 1080p60 video stream and the compressed video stream is one of a 1080p30 video stream and a 1080i60 video stream. In another non-limiting example of implementation, the video stream is a 720p120 video stream and the compressed video stream is one of a 720p60 video stream and a 720i120 video stream.

In accordance with another broad aspect, the present invention provides a method of transmitting a high definition digital image stream, the image stream being characterized by a frame rate of at least 60 frames per second. The method includes, for each discrete pair of time-successive first and second frames of the stream, sampling the pixels of the first and second frames according to a staggered quincunx sampling pattern, thereby decimating from each frame half a number of original pixels. The method also includes creating a new frame by juxtaposing the sampled pixels of the first frame and the sampled pixels of the second frame, and transmitting the new frames in a new image stream characterized by half the frame rate of the original image stream.

In accordance with yet another broad aspect, the present invention provides a method of processing a compressed digital video signal, the compressed video signal having a plurality of image frames and being characterized by a vertical resolution and a frame rate. The method includes applying a temporal demultiplexing operation to the image frames of the compressed video signal in order to generate a new video signal having the same vertical resolution and double the frame rate of the compressed video signal.

In accordance with a further broad aspect, the present invention provides a system for transmitting a digital video stream, the video stream having a plurality of frames and being characterized by a vertical resolution and a frame rate. The system includes a processor for receiving the video stream, the processor being operative to apply a temporal multiplexing operation to the frames of the video stream in order to generate a new video stream having the same vertical resolution and half the frame rate of the original video stream. The system also includes a compressor for receiving the new video stream and being operative to apply a compression operation to the new video stream for generating a compressed video stream, as well as an output for transmitting the compressed video stream.

In accordance with yet a further broad aspect, the present invention provides a system for processing a compressed video stream, the compressed video stream having a plurality of frames and being characterized by a vertical resolution and a frame rate. The system includes a decompressor for receiving the compressed video stream, the decompressor being operative to apply a decompression operation to the frames of the compressed video stream for generating a decompressed video stream; a processor for receiving the decompressed video stream from the decompressor, the processor being operative to apply a temporal demultiplexing operation to the frames of the decompressed video stream in order to generate a new video stream having the same vertical resolution and double the frame rate of the compressed video stream; and an output for releasing the new video stream.

In accordance with another broad aspect, the present invention provides a processing unit for processing frames of a digital video stream, the video stream characterized by a vertical resolution and a frame rate, the processing unit operative to apply a temporal multiplexing operation to the frames of the video stream in order to generate a compressed video stream having the same vertical resolution and half the frame rate of the video stream.

In accordance with yet another broad aspect, the present invention provides a processing unit for processing frames of a compressed video stream, the compressed video stream characterized by a vertical resolution and a frame rate, the processing unit operative to apply a temporal demultiplexing operation to the frames of the compressed video stream in order to generate a new video stream having the same vertical resolution and double the frame rate of the compressed video stream.

### BRIEF DESCRIPTION OF THE DRAWINGS

The invention will be better understood by way of the following detailed description of embodiments of the invention with reference to the appended drawings, in which:

FIG. 1 is a schematic representation of a system for transmitting a digital image stream, according to the prior art;

FIG. 2 illustrates a simplified system for processing and decoding a compressed digital image stream, according to the prior art;

FIG. 3 is a schematic representation of a system for transmitting high definition image streams, according to an embodiment of the present invention;

FIG. 4A is an example of a pair of original time-successive image frames of a high definition video stream;

FIGS. 4B and 4C illustrate quincunx sampling, horizontal collapsing and merging together of the two frames of FIG. 4A, according to a non-limiting example of implementation of the present invention;

FIG. 5 is a flow diagram of a process implemented by the temporal multiplexer of FIG. 3, according to a non-limiting example of implementation of the present invention;

FIG. 6 illustrates the pair of time-successive image frames of FIG. 4B, after interpolation of missing pixels at the receiving end of the image stream transmission; and

FIG. 7 is a flow diagram of a process implemented by the image processor of FIG. 2, according to a non-limiting example of implementation of the present invention.

### DETAILED DESCRIPTION

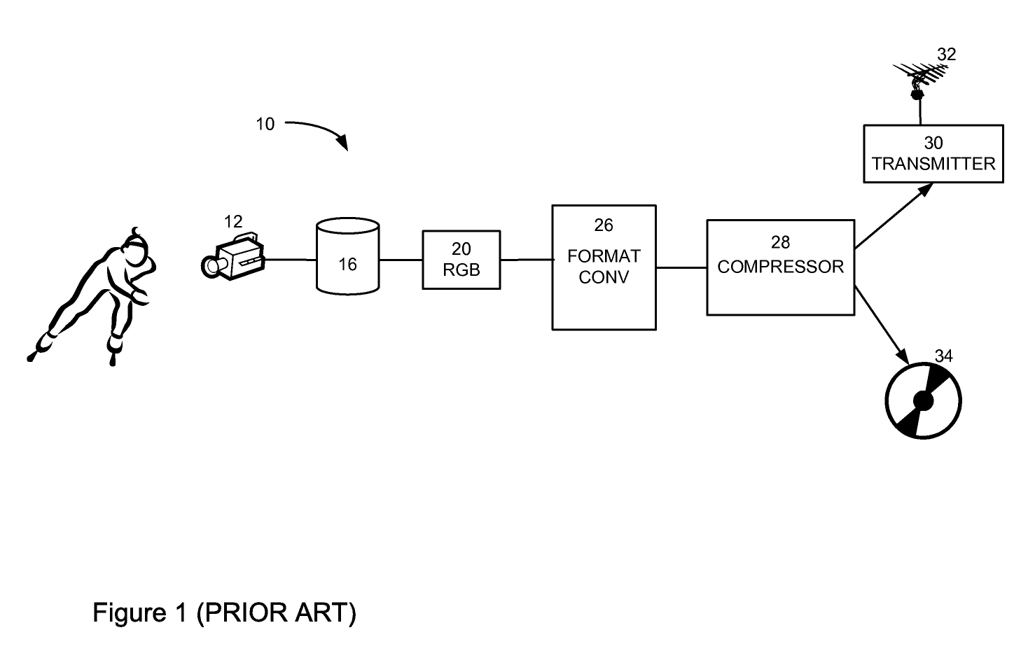

FIG. 1 illustrates an example of a system 10 for generating and transmitting a digital image stream, according to the prior art. The image sequences generated by a source represented by camera 12 are stored into digital data storage media 16. Alternatively, image sequences may be obtained from digitized movie films or any other source of digital picture files stored in a digital data storage medium or inputted in real time as a digital video signal suitable for reading by a microprocessor based system.

The camera 12 is operative to capture video and generate image sequences in a particular digital format, that is using a specific scanning method and having a specific resolution and frame rate. For example, camera 12 may capture and generate 720p60 video material, 1080i60 video material or 1080p60 material, among many other possibilities. The digital image sequences stored in the storage media 16 are thus characterized by the particular digital format in which they were captured by the camera 12.

Stored digital image sequences are then converted to an RGB format by a processor 20, after which the RGB signal may undergo another format conversion by a processor 26 before being compressed (or encoded) into a standard video bit stream format, such as for example MPEG2, by a typical compressor (or encoder) circuit 28. The resulting coded program can then be broadcasted on a single standard channel through, for example, transmitter 30 and antenna 32 or recorded on a conventional medium such as a DVD or Blu-Ray disk 34. Alternative transmission medium could be, for instance, a cable distribution network or the Internet.

It is clear that, when transmitting digital image streams, some form of compression (also referred to as encoding) is typically applied to the image streams in order to reduce data storage volume and bandwidth requirements. For instance, it is known to use a quincunx or checkerboard pixel decimation pattern in video compression or encoding. Obviously, such compression (or encoding) leads to a necessary decompression (or decoding) operation at the receiving end, in order to retrieve the original image streams.

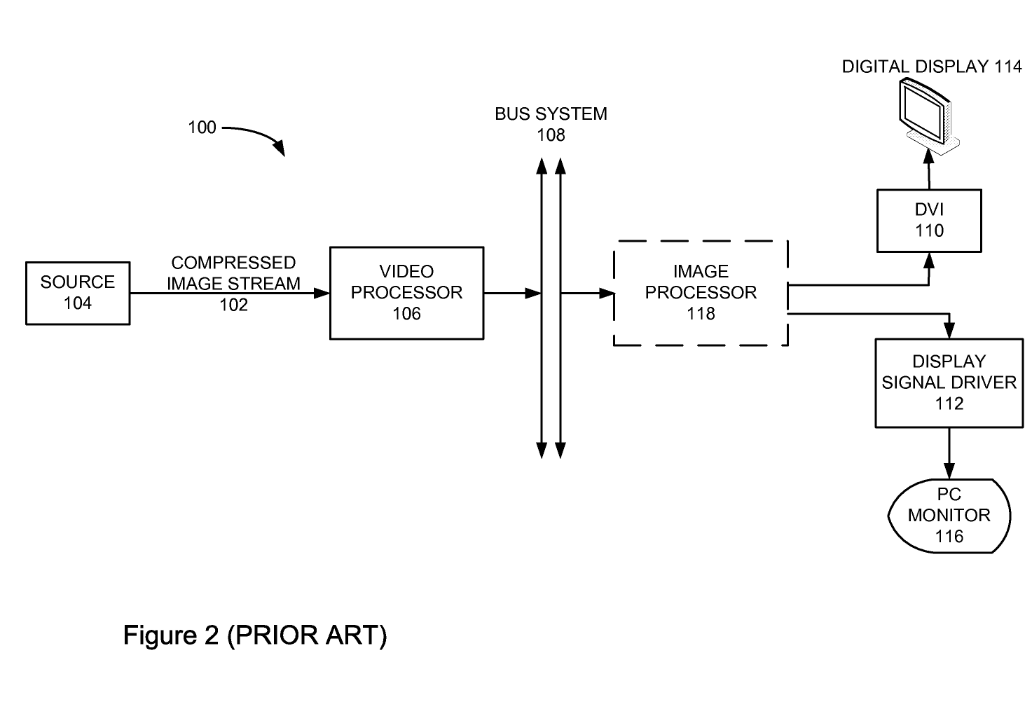

Turning now to FIG. 2, there is illustrated a simplified computer architecture 100 for receiving and processing a compressed (or encoded) digital image stream, according to the prior art. The compressed image stream may be characterized by any one of various different possible digital formats (including, among other variables, scanning method, frame rate and resolution). As shown, the compressed image stream 102 is received by video processor 106 from a source 104. The source 104 may be any one of various devices providing a compressed (or encoded) digitized video bit stream, such as for example a wireless transmitter or a DVD drive, among other possibilities. The video processor 106 is connected via a bus system 108 to various back-end components. In the example shown in FIG. 2, a digital visual interface (DVI) 110 and a display signal driver 112 are capable to format pixel streams for display on a digital display 114 and a PC monitor 116, respectively.

Video processor 106 is capable to perform various different tasks, including for example some or all video playback tasks, such as scaling, color conversion, compositing, decompression/decoding and deinterlacing, among other possibilities. Typically, the video processor 106 would be responsible for processing the received compressed image stream 102, as well as submitting the compressed image stream 102 to color conversion and compositing operations, in order to fit a particular resolution. Although the video processor 106 may also be responsible for decompressing/decoding and deinterlacing the received compressed image stream 102, this interpolation functionality may alternatively be performed by a separate, back-end processing unit 118 that interfaces between the video processor 106 and both the DVI 110 and display signal driver 112.

In commonly assigned U.S. Pat. No. 7,580,463, the specification of which is hereby incorporated by reference, it is disclosed that stereoscopic image pairs of a stereoscopic video can be compressed by removing pixels in a checkerboard pattern and then collapsing the checkerboard pattern of pixels horizontally. The two horizontally collapsed images are placed in a side-by-side arrangement within a single standard image frame, which is then subjected to conventional image compression/encoding and, at the receiving end, conventional image decompression/decoding. The decompressed standard image frame is then further decoded, whereby it is expanded into the checkerboard pattern and the missing pixels are spatially interpolated.

It has now been discovered that this process described in U.S. Pat. No. 7,580,463 with regard to a three-dimensional stereoscopic program can be adapted for use in transmitting high definition video, such that video of high resolution and high frame rate can be transmitted with the same bandwidth usage as for video of the same resolution but half the frame rate. Accordingly, the present invention is directed to a method and system for transmitting and processing high definition digital image streams, whereby the existing broadcasting equipment and channels currently in widespread use can support 1080p60 video or other such high resolution/high frame rate video.

It should be understood that the expressions “decoded” and “decompressed” are used interchangeably within the present description, as are the expressions “encoded” and “compressed”. Although examples of implementation of the invention will be described herein with reference to transmitting and processing 1080p60 video, it should be understood that the scope of the invention also encompasses other formats and types of video. Furthermore, although discussion will focus on the processing of a pair of time-successive images, where these images may contain different video content, the present invention should also be considered to apply to the processing of any pair of video images.

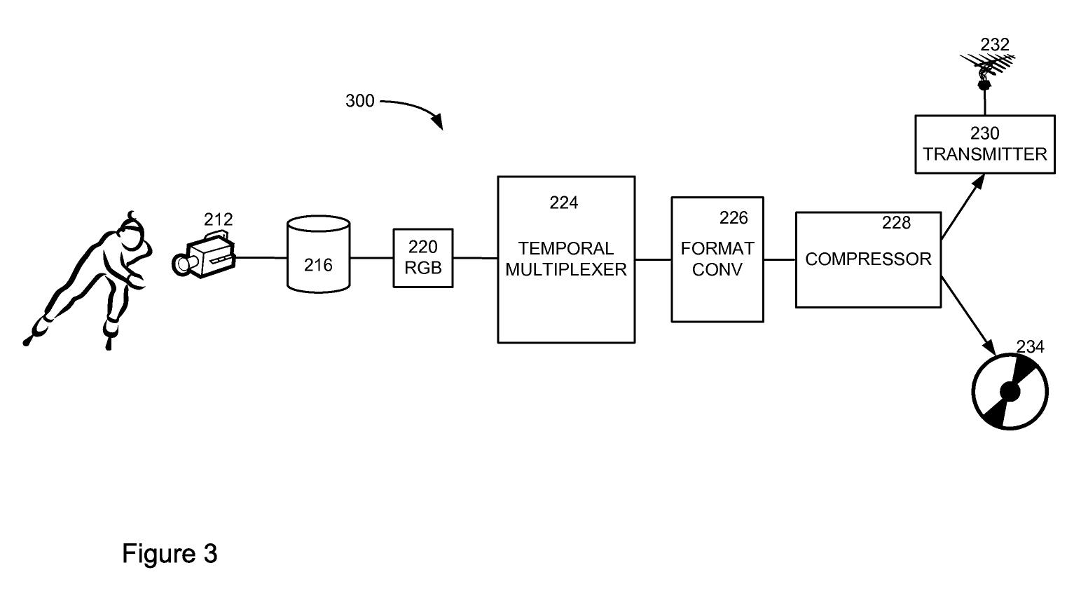

FIG. 3 illustrates a system 300 for generating and transmitting a digital image stream, according to an embodiment of the present invention. The camera 212 is operative to capture video and generate digital image sequences in a first format, characterized by a first frame rate. The image sequences are stored in the storage media 216 and then converted to an RGB format by a processor 220, after which the video signal is fed to a temporal multiplexer 224. This temporal multiplexer 224 is operative to apply a temporal multiplexing to the frames of the video signal, such that for every Y frames of the video signal input to the multiplexer 224, only Y/2 compressed frames are output from the multiplexer 224. More specifically, the temporal multiplexer 224 compresses each discrete pair of time-successive frames of the video signal into a single frame, thus reducing by half the frame rate of the video signal. The image sequences output by the temporal multiplexer 224 are therefore in a second format, characterized by a second frame rate that is half the first frame rate. Note that these image sequences in the second format output by the temporal multiplexer 224 may be output using either progressive scanning or interlaced scanning; in the latter case the Y/2 frames being output as Y interlaced fields.

The temporally compressed RGB signal output by the multiplexer 224 may undergo another format conversion by a processor 226, before being further compressed or encoded into a standard video bit stream format, such as for example MPEG2, by a typical compressor (or encoder) circuit 228. The resulting coded and compressed program can then be broadcasted on a single standard channel through, for example, transmitter 230 and antenna 232 or recorded on a conventional medium such as a DVD or Blu-Ray disk 234. Alternative transmission medium could be, for instance, a cable distribution network or the Internet.

At the receiving end, a corresponding temporal de-multiplexing operation is required to restore the original video signal. In the case of a system for processing and decoding a compressed digital image stream such as that shown in FIG. 2, the necessary de-multiplexing functionality may be performed by the image processor 118, which would be operative to temporally decompress and interpolate the received video sequence (characterized by the second format) in order to reconstruct the original video (characterize by the first format). More specifically, the image processor 118 processes each frame of the received video sequence in the second format in order to reconstruct two frames of the original video signal in the first format, thus doubling the frame rate of the received video sequence.

Advantageously, by temporally compressing video in this way prior to its transmission or recording, it is possible to transmit or record high definition video having a high frame rate without adding any burden to the bandwidth of the transmission or recording medium, since this high frame rate is halved during the transmission or recording. Although this temporal compression results in the decimation of certain pixels from each frame of the original video signal, the value of the missing pixels can be reliably interpolated and the original frames reconstructed at the receiving end, as will be discussed below.

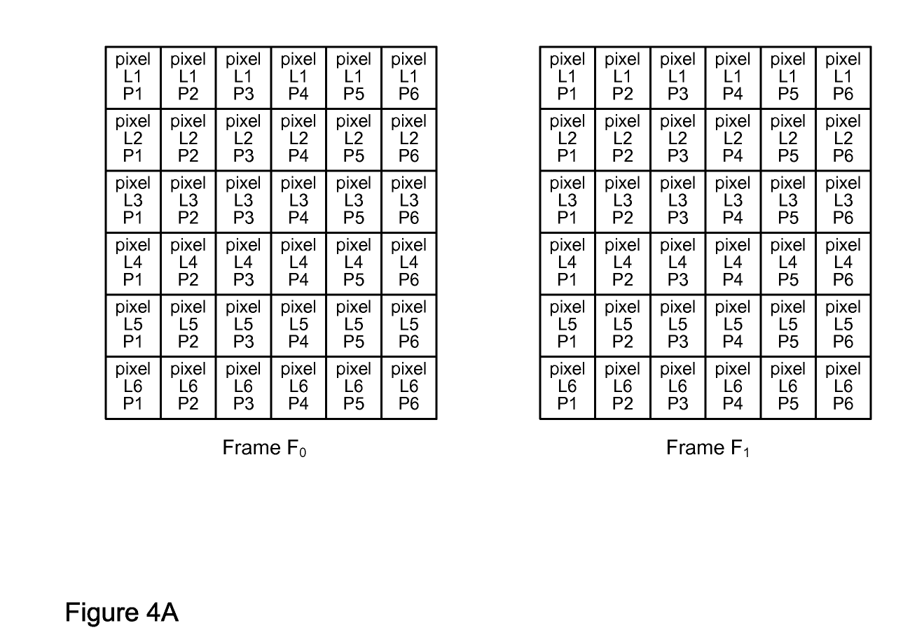

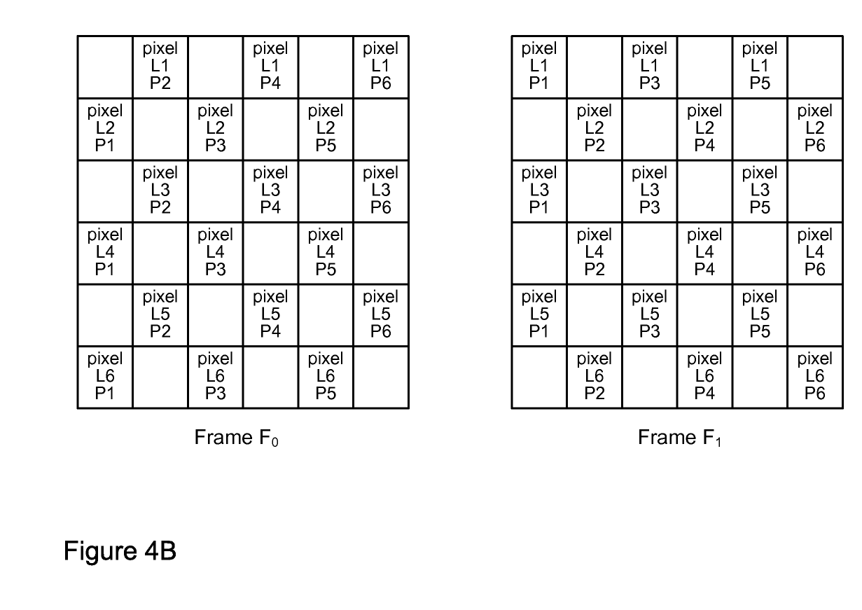

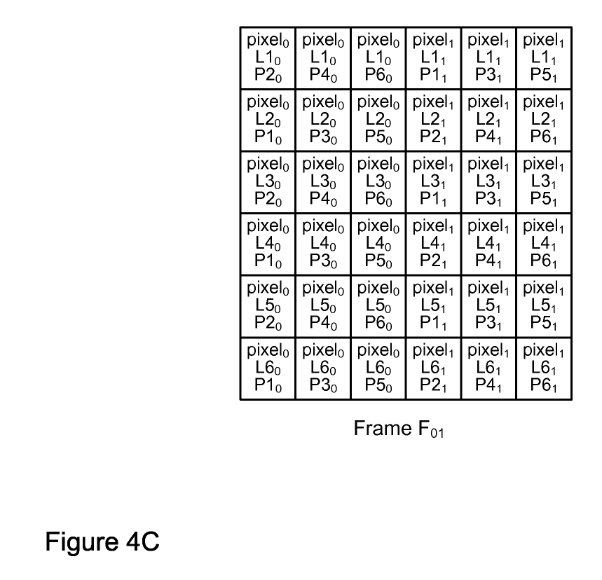

Specific to the functionality of the temporal multiplexer 224, FIG. 4A illustrates a pair of time-successive image frames F₀ and F₁ received by the temporal multiplexer 224 from the processor 220, according to a non-limiting example of implementation of the present invention. Although image frames actually contain hundreds of pixels, for ease of illustration and explanation the frames F₀ and F₁ are shown with 36 pixels each. In FIG. 4A, these pixels are original pixels arranged in rows and columns, before any sampling has been performed. With regard to the pixel identification, L designates the vertical position of a pixel in terms of line number and P designates the horizontal position of a pixel in terms of pixel number/line. The temporal multiplexer 224 is operative to perform a decimation process on each one of frames F₀ and F₁, in order to reduce the amount of information contained in each respective frame.

In this example of implementation, the temporal multiplexer 224 samples each received frame in a quincunx pattern. Quincunx sampling, as it is well-known to those skilled in the art, is a sampling method by which sampling of odd pixels (and discarding of even pixels) alternates with sampling of even pixels (and discarding of odd pixels) for consecutive rows, such that the sampled pixels form a checkerboard pattern. FIG. 4B illustrates a non-limiting example of sampled frames F₀ and F₁, where the temporal multiplexer 224 has decimated frame F₀ by sampling the even-numbered pixels from the odd-numbered lines of the frame (e.g. sampling pixels P2, P4 and P6 from line L1) and the odd-numbered pixels from the even-numbered lines of the frame (e.g. sampling pixels P1, P3 and P5 from line L2). In contrast, the temporal multiplexer 224 has decimated frame F₁ by sampling the odd-numbered pixels from the odd-numbered lines of the frame (e.g. pixels P1, P3 and P5 from line L1) and the even-numbered pixels from the even-numbered lines of the frame (e.g. pixels P2, P4 and P6 from line L2). Alternatively, both frames F₀, F₁ may be identically sampled according to the same quincunx sampling pattern.

Note that various different sampling patterns, quincunx or other, may be applied by the temporal multiplexer 224 to the frames F₀, F₁ in order to reduce by half the amount of information contained in each frame, without departing from the scope of the present invention. Furthermore, for a pair of time-successive frames, such as F₀ and F₁, the temporal multiplexer 224 may apply the same sampling pattern to both frames, complementary sampling patterns to the two frames or a different sampling pattern to each frame.

Once the frames F₀, F₁ have been sampled, they are collapsed horizontally and placed side by side within new image frame F₀₁, as shown in FIG. 4C. Thus, each one of time-successive frames F₀ and F₁ is spatially compressed by 50% by discarding half of the pixels of the respective frame, after which compression the two sampled frames are merged together to create a new image frame F₀₁. This side-by-side compressed transport format of frames F₀ and F₁ within new image frame F₀₁ is mostly transparent and unaffected by further compression/decompression that may occur downstream in the process, regardless of which scanning system (progressive or interlaced) is used to transmit frame F₀₁.

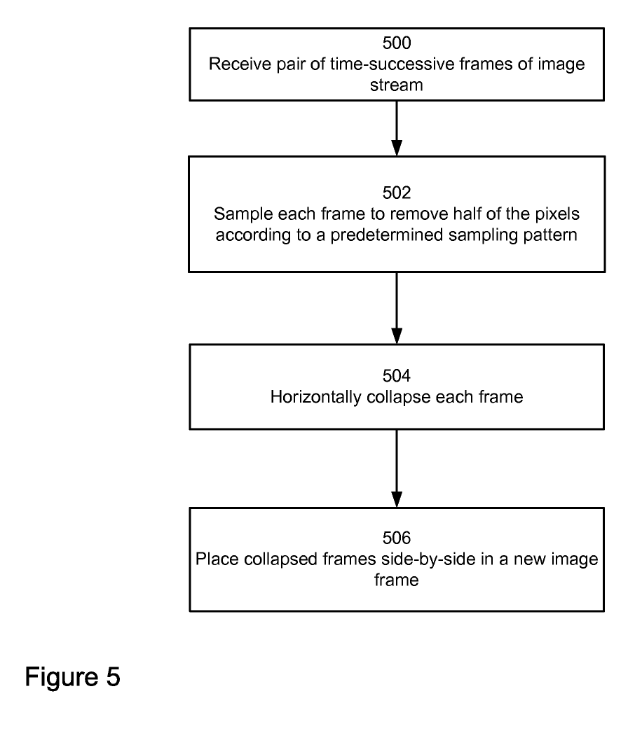

FIG. 5 is a flow diagram illustrating the processing implemented by the temporal multiplexer 224, according to a non-limiting example of implementation of the present invention. At step 500, first and second time-successive frames (F₀, F₁) of an image stream are received by the temporal multiplexer 224 from the processor 220. At step 502, the pixels of each frame are sampled according to a predetermined sampling pattern (e.g. quincunx sampling), in order to decimate half of the pixels from each frame. The sampled frames are next collapsed horizontally at step 504, after which the two compressed frames are merged together into a new image frame (F₀₁) at step 506.

It is important to note that, in practice, the pixel sampling, pixel removal and horizontal collapsing steps described above and shown in FIGS. 4B and 4C may be implemented automatically within the temporal multiplexer 224 using appropriate hardware and/or software that could, for example, read the appropriate odd or even-numbered pixels from each one of frames F₀, F₁ and place them directly in a frame buffer for new frame F₀₁. More specifically, the temporal multiplexer 224 may access, store data in and/or retrieve data from a memory, either local to the multiplexer 224 or remote (e.g. a host memory via bus system), in the course of performing the pixel sampling, horizontal collapsing and frame merging steps. Pixel information is transferred into and/or read from the appropriate memory location(s) of one or more frame buffer(s), in order to build the merged image frames (F₀₁).

In a specific example, the camera 212 generates 1080p60 image sequences. In other words, the camera 212 uses progressive scanning to generate 1920×1080 resolution video at a rate of 60 frames per second. The temporal multiplexor 224 applies the above-described temporal multiplexing process to the frames of the 1080p60 video signal, such that for every 60 frames input to the multiplexer 224, only 30 compressed frames are output from the multiplexer 224, each compressed frame consisting of a merged pair of time-successive frames of the original 1080p60 program. More specifically, the temporal multiplexer 224 compresses each pair of time-successive frames of the 1080p60 video signal into a single frame, thereby reducing the frame rate by half and compressing the 1080p60 video into 1080p30 or 1080i60 video. In this way, a full high definition 1080p60 program can be broadcast/recorded with the bandwidth usage and frame rate of a 1080p30 or 1080i60 program, using the existing broadcasting equipment and channels currently in widespread use.

In another specific example, the camera 212 generates 720p120 image sequences, using progressive scanning to generate 1280×720 resolution video at a rate of 120 frames per second. In this case, the temporal multiplexor 224 processes the frames of the 720p120 video signal, such that for every 120 frames input to the multiplexer 224, only 60 compressed frames are output from the multiplexer 224, thereby reducing the frame rate by half and compressing the 720p120 video into 720p60 or 720i120 video.

In order to successfully broadcast/record high definition video, such as 1080p60 video, using the above-discussed technique, complementary processing must be implemented at the receiving end in order to reconstruct the original high definition video from the received temporally multiplexed and compressed video. With reference to the prior art system shown in FIG. 2, for example, this complementary processing may be implemented by the image processor 118. More specifically, the image processor 118 can be designed to apply the appropriate temporal demultiplexing and spatial interpolation operations to the received compressed image stream in order to rebuild the original high definition video, following any standard decompression/decoding operations the image stream may undergo (e.g. MPEG2 decompression operations). Note that these appropriate temporal demultiplexing and spatial interpolation operations applied by the image processor 118 are based on the specific pixel sampling pattern(s) applied by the source to the original high definition video.

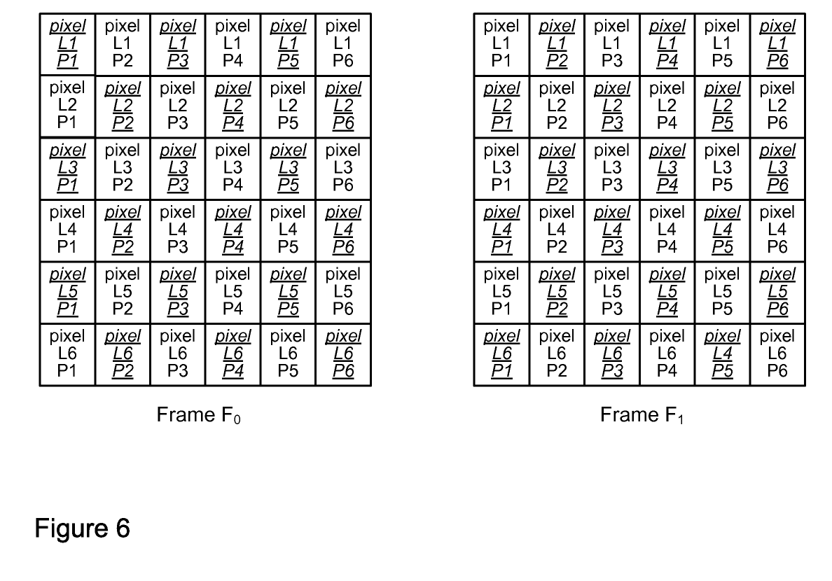

Continuing with the example illustrated in FIGS. 4A, 4B and 4C, the image processor 118 operates on the basis that each frame F₀₁ of the received compressed image stream contains half the pixels of an original first frame and half the pixels of an original second frame, arranged side-by-side in the frame F₀₁, where the first and second frames are time-successive in the original image stream. Thus, the image processor 118 temporally de-multiplexes each frame F₀₁ in order to extract therefrom sampled frames F₀ and F₁. Once the frame F₀₁ has been separated out into frames F₀ and F₁, each frame is horizontally inflated (i.e. de-collapsed) to reveal the missing pixels, that is the pixels that were decimated from the original frames at the source. The image processor 118 is then operative to reconstruct each frame F₀, F₁, by spatially interpolating each missing pixel at least in part on a basis of the original pixels surrounding the respective missing pixel. Upon completion of the spatial interpolation process, each reconstructed frame F₀, F₁ will contain half original pixels and half interpolated pixels, as shown in FIG. 6. For example, line L1 of frame F₀ includes interpolated pixels P1, P3 and P5, while line L1 of frame F1 includes interpolated pixels P2, P4 and P6.

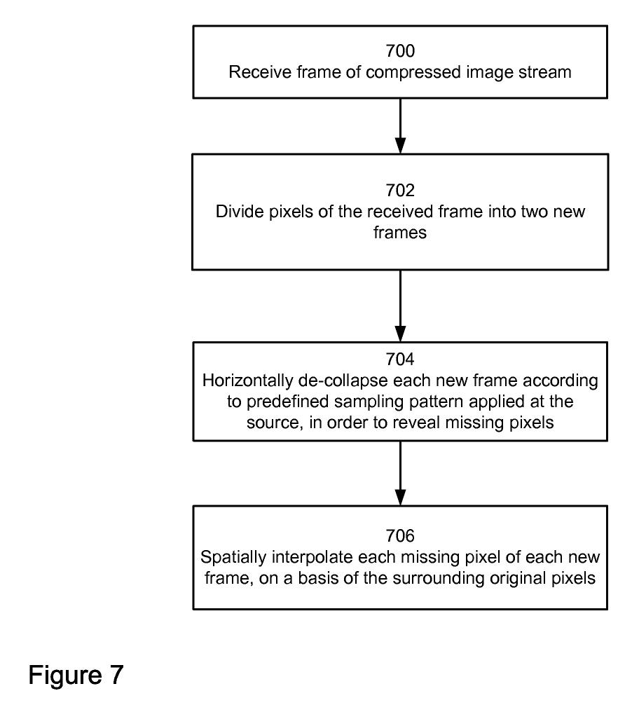

FIG. 7 is a flow diagram illustrating the processing implemented by the image processor 118, according to a non-limiting example of implementation of the present invention. At step 700, a frame (F₀₁) of the compressed image stream is received by the image processor 118. At step 702, the pixels of the received frame are split into two new frames (F₀, F₁), each of which is horizontally de-collapsed to reveal the missing pixels at step 704. In other words, the pixels of each new frame (F₀, F₁) are arranged on a basis of the predefined sampling pattern (e.g. quincunx sampling) applied at the source, in order to reveal the missing pixels in each new frame. At step 706, each missing pixel of each new frame (F₀, F₁) is spatially interpolated on a basis of the surrounding original pixels, in order to reconstruct the new frames (F₀, F₁).

In practice, the pixel splitting, horizontal de-collapsing and spatial interpolation steps described above and shown in FIG. 6 may be implemented automatically within the image processor 118 using appropriate hardware and/or software that could, for example, read the appropriate odd or even-numbered pixels from frame F₀₁ and place them directly in frame buffers for new frames F₀ and F₁. More specifically, the image processor 118 may access, store data in and/or retrieve data from a memory, either local to the processor 118 or remote (e.g. a host memory via bus system), in the course of performing the pixel splitting, horizontal de-collapsing and spatial interpolation steps. Pixel information is transferred into and/or read from the appropriate memory location(s) of one or more frame buffer(s), in order to build the new image frames (F₀ and F₁). Note that the spatial interpolation of a missing pixel may be carried out when one or more pixels, such as the original pixels surrounding the particular missing pixel, are being transferred to or from memory.

Various different interpolation methods are possible and can be implemented by the image processor 118 in order to reconstruct the missing pixels of the frames F₀, F₁, without departing from the scope of the present invention. The underlying premise of spatial interpolation in the context of the present invention is that the values of adjacent pixels within an image frame are not so dissimilar. In a specific, non-limiting example, the pixel interpolation method relies on the fact that the value of a missing pixel is related to the value of original neighbouring pixels. The values of original neighbouring pixels can therefore be used in order to reconstruct missing pixel values. In commonly assigned US patent application publication 2005/0117637 A1, the specification of which is hereby incorporated by reference, several methods and algorithms are disclosed for reconstructing the value of a missing pixel, including for example the use of a weighting of a horizontal component (HC) and a weighting of a vertical component (VC) collected from neighbouring pixels, as well as the use of weighting coefficients based on a horizontal edge sensitivity parameter.

In a specific example, the image processor 118 processes the frames of a 1080p30 image stream in order to generate therefrom the frames of the original 1080p60 image stream. For every frame F₀₁ of the 1080p30 image stream, the image processor 118 is operative to generate two time-successive frames F₀, F₁ of the original 1080p60 image stream, interpolating missing pixels on a basis of the original pixels present in the 1080p30 frame. It follows that for every 30 frames of the 1080p30 image stream, the image processor 118 is operative to generate 60 frames of the 1080p60 image stream, thus reconstructing video having a frame rate of 60 frames per second from video having a frame rate of 30 frames per second.

Although discussed in the context of a high definition program such as 1080p60 video, the techniques of the present invention are applicable to all types of digital image streams and are not limited in application to any one specific type of video format. Furthermore, the techniques may be applied regardless of the particular type of encoding/decoding operations that are applied to the video sequence, whether it be compression encoding/decoding or some other type of encoding/decoding. Finally, the techniques may even be applied if the digital sequence is to be transmitted/recorded without undergoing any further type of encoding or compression (e.g. transmitted/recorded as uncompressed data rather than JPEG, MPEG2 or other), without departing from the scope of the present invention.

The various components and modules of the computer architecture 100 (see FIG. 2) and the system 300 (see FIG. 3) may all be implemented in software, hardware, firmware or any combination thereof, within one piece of equipment or split up among various different pieces of equipment. Specific to the temporal multiplexer 224 of the system 300, its functionality may be built into one or more processing units of existing transmission systems, or more specifically of existing encoding systems. Alternatively, existing encoding systems may be provided with a dedicated processing unit to perform the temporal multiplexing operations of the present invention. Similarly, at the receiving end, the temporal de-multiplexing operations of the present invention may be built into one or more processing units of existing decoding systems or, alternatively, performed by a dedicated image processor provided within the existing decoding systems. In the course of manipulating the pixels of the image frames during pixel sampling, generation of new frames (either by merging two frames of the original image stream into one new frame or by separating out two new frames from one frame of the compressed image stream) and/or spatial interpolation of missing pixels, the respective processing unit(s) may temporarily store lines or pixels of one or more frames in a memory, either local to the processing unit or remote (e.g. a host memory via bus system). It should be noted that storage and retrieval of frame lines or pixels may be done in more than one way, without departing from the scope of the present invention.

Accordingly, the temporal multiplexing and de-multiplexing functionality of the present invention may be implemented in software, hardware, firmware or any combination thereof within existing encoding/decoding systems. Obviously, various different software, hardware and/or firmware based implementations of the temporal multiplexing and de-multiplexing techniques of the present invention are possible and included within the scope of the present invention.

Although various embodiments have been illustrated, this was for the purpose of describing, but not limiting, the present invention. Various possible modifications and different configurations will become apparent to those skilled in the art and are within the scope of the present invention, which is defined more particularly by the attached claims.

What is claimed is:

1. A method of transmitting a digital video stream, said video stream having a plurality of image frames and being characterized by a vertical resolution and a frame rate, said method comprising:
a. applying a temporal multiplexing operation to the image frames of said video stream in order to generate a compressed video stream having the same vertical resolution and half the frame rate of said video stream;
b. transmitting said compressed video stream.

2. A method as defined in claim 1, wherein said applying a temporal multiplexing operation includes:
a. identifying first and second image frames that are time-successive within said video stream;
b. sampling the pixels of said first and second frames according to at least one predefined sampling pattern, thereby decimating half a number of original pixels from each frame;
c. creating a new image frame by merging together the sampled pixels of said first frame and the sampled pixels of said second frame.

3. A method as defined in claim 2, wherein said sampling of said first and second frames includes generating first and second sampled frames, respectively, each sampled frame having half a number of original pixels.

4. A method as defined in claim 3, wherein the original pixels of each sampled frame form a staggered quincunx pattern, the original pixels surrounding missing pixels.

5. A method as defined in claim 4, wherein said creating a new image frame includes:
a. horizontally collapsing each of said first and second sampled frames;
b. juxtaposing said sampled first frame and said sampled second frame to form said new image frame.

6. A method as defined in claim 2, wherein for X image frames of said video stream, said method includes:
a. dividing said X image frames into X/2 discrete pairs of time-successive image frames;
b. applying said temporal multiplexing operation to each of said X/2 pairs of time-successive image frames, thereby generating X/2 new image frames;
c. generating said compressed video stream with said X/2 new image frames.

7. A method as defined in claim 1, wherein said video stream is a 1080p60 video stream and said compressed video stream is one of a 1080p30 video stream and a 1080i60 video stream.

8. A method as defined in claim 1, wherein said video stream is a 720p120 video stream and said compressed video stream is one of a 720p60 video stream and a 720i120 video stream.

9. A method of transmitting a high definition digital image stream, said image stream being characterized by a frame rate of at least 60 frames per second, said method comprising:
a. for each discrete pair of time-successive first and second frames of said stream:
i. sampling the pixels of said first and second frames according to a staggered quincunx sampling pattern, thereby decimating from each frame half a number of original pixels;
ii. creating a new frame by juxtaposing the sampled pixels of said first frame and the sampled pixels of said second frame;
b. transmitting said new frames in a new image stream characterized by half the frame rate of the original image stream.

10. A method as defined in claim 9, wherein said high definition digital image stream is a 1080p60 image stream and said new image stream is one of a 1080p30 image stream and a 1080i60 image stream.

11. A method of processing a compressed digital video signal, said compressed video signal having a plurality of image frames and being characterized by a vertical resolution and a frame rate, said method comprising applying a temporal demultiplexing operation to the image frames of said compressed video signal in order to generate a new video signal having the same vertical resolution and double the frame rate of said compressed video signal.

12. A method as defined in claim 11, wherein said applying a temporal demultiplexing operation includes:
a. for each image frame of said compressed video signal, dividing the pixels of the respective frame into two new time-successive image frames;
b. arranging the pixels in the new image frames on a basis of at least one predefined sampling pattern, whereby each new image frame has missing pixels;
c. spatially interpolating the missing pixels in each new image frame on a basis of the pixels surrounding the missing pixels.

13. A method as defined in claim 12, wherein upon arranging of the pixels in the new image frames, half of the pixels of each new image frame are missing.

14. A method as defined in claim 13, wherein the predefined sampling pattern defines that the pixels of each new image frame form a staggered quincunx pattern, in which original pixels surround missing pixels.

15. A method as defined in claim 12, wherein for Y image frames of said compressed video signal, said method includes:
a. dividing the pixels of each one of said Y image frames into a pair of new time-successive image frames, thereby generating 2Y new image frames;
b. spatially interpolating the missing pixels in each one of said 2Y new image frames;
c. generating said new video signal with said 2Y new image frames.

16. A method as defined in claim 11, wherein said compressed video signal is one of a 1080p30 video signal and a 1080i60 video signal and said new video signal is a 1080p60 video signal.

17. A method as defined in claim 11, wherein said compressed video signal is one of a 720p60 video signal and a 720i120 video signal and said new video signal is a 720p120 video signal.

18. A system for transmitting a digital video stream, said video stream having a plurality of frames and being characterized by a vertical resolution and a frame rate, said system comprising:
a. a processor for receiving said video stream, said processor being operative to apply a temporal multiplexing operation to the frames of said video stream in order to generate a new video stream having the same vertical resolution and half the frame rate of said original video stream;
b. a compressor for receiving said new video stream and being operative to apply a compression operation to said new video stream for generating a compressed video stream;
c. an output for transmitting said compressed video stream.

19. A system for processing a compressed video stream, said compressed video stream having a plurality of frames and being characterized by a vertical resolution and a frame rate, said system comprising:
a. a decompressor for receiving said compressed video stream, said decompressor operative to apply a decompression operation to the frames of said compressed video stream for generating a decompressed video stream;
b. a processor for receiving said decompressed video stream from said decompressor, said processor being operative to apply a temporal demultiplexing operation to the frames of said decompressed video stream in order to generate a new video stream having the same vertical resolution and double the frame rate of said compressed video stream;
c. an output for releasing said new video stream.

20. A processing unit for processing frames of a digital video stream, said video stream characterized by a vertical resolution and a frame rate, said processing unit operative to apply a temporal multiplexing operation to the frames of said video stream in order to generate a compressed video stream having the same vertical resolution and half the frame rate of said video stream.

21. A processing unit for processing frames of a compressed video stream, said compressed video stream characterized by a vertical resolution and a frame rate, said processing unit operative to apply a temporal demultiplexing operation to the frames of said compressed video stream in order to generate a new video stream having the same vertical resolution and double the frame rate of said compressed video stream.
